(19) United States
(12) Patent Application Publication
(10) Pub. No.: US 2007/0190323 A1
(43) Pub. Date: Aug. 16, 2007

(54) Method of producing metal nanoparticles

(75) Inventors: Kwi-Jong Lee, Suwon-si (KR); Jae-Woo Joung, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/655,187

(22) Filed: Jan. 19, 2007

(30) Foreign Application Priority Data
Feb. 15, 2006 (KR) 10-2006-0014609

(51) Int. Cl. B32B 5/16; C09K 3/00

(52) U.S. Cl. 428/402; 252/182.12

(57) ABSTRACT

The present invention provides a method of producing metal nanoparticles, having a high yield rate achieved by superior dispersion stability even in a polar solvent, producing a large amount of particles of uniform size. Also, the invention provides metal nanoparticles and a producing method of metal nanoparticles, employing a polyacid as a stabilizing agent to control the size of particles even with a smaller amount than using other macromolecular stabilizing agents, allowing the particles to have dispersion stability. According to one aspect of the invention may provide a method of manufacturing metal nanoparticles, using a polyacid as a stabilizing agent to produce nano-sized metal nanoparticles from a metal precursor. Here, a reducing agent may be further added.

### CROSS-REFERENCE TO RELATED APPLICATIONS

This application claims the benefit of Korean Patent Application No. 10-2006-0014609 filed on Feb. 15, 2006, with the Korea Intellectual Property Office, the contents of which are incorporated here by reference in their entirety.

### BACKGROUND

1. Technical Field

The present invention relates to a method of producing metal nanoparticles and nanoparticles produced thereby, in particular, to a method of producing metal nanoparticles in a polar solvent and nanoparticles produced thereby.

2. Description of the Related Art

Major ways to produce metal nanoparticles are the chemical synthesis method, the mechanical production method, and the electrical production method. However, in case of the mechanical production method, which uses mechanical power for comminuting, it is hard to produce highly pure particles because of intrusion of impurities during the process and impossible to form uniform-sized metal nanoparticles. Further, the electrical production method by electrolysis has shortcomings in that it requires a long period for production time and provides a low yield rate caused by low concentration. The chemical synthesis method includes the vapor method such as plasma or thermal evaporation, which involves a use of highly expensive equipments, and the solution (colloid) method, which allows to generate uniform particles with low cost.

A method of producing metal nanoparticles by the solution method up to now includes dissociating a metal compound in a water-based media and then producing metal nanoparticles in the form of hydrosol using a reducing agent or a surfactant. However, the production of metal nanoparticles by this existing solution method provides a very low yield rate, as it is limited by the concentration of the metal compound solution. That is, it is possible to form metal nanoparticles of uniform size only when the concentration of the metal compound is less than mM. Thus, there is a limit also on the yield of metal nanoparticles, and to obtain metal nanoparticles of uniform size in quantities of several grams, 1000 liters or more of functional group are needed. This represents a limitation to efficient mass production. In addition, the un-reactant remaining after completion of the reaction reduces the yield rate, and a vast amount of loss which occurs during the separation step of formed metal nanoparticles results in further reduction of the yield rate. Furthermore, when the generated metal nanoparticles are re-dispersed in order to use them in various areas, the dispersion stability is important.

### SUMMARY

The present invention provides a method of producing metal nanoparticles which allows a high yield rate achieved by superior dispersion stability in a polar solvent and production of large amount of uniform particles, and the metal nanoparticles thus produced.

Also, the present invention provides metal nanoparticles and a producing method of metal nanoparticles, employing a polyacid as a stabilizing agent to control the size of particles even with a smaller amount than using other polymer stabilizing agents and allowing the particles to have dispersion stability.

Additional aspects and advantages of the present invention will be set forth in part in the description which follows and, in part, will be obvious from the description, or may be learned by practice of the invention.

According to one aspect of the invention may provide a method of manufacturing metal nanoparticles, using the polyacid as a stabilizing agent to produce nano-sized metal nanoparticles from a metal precursor in a polar solvent. Here, a reducing agent may be further added.

The method may further include mixing the metal precursor and the polyacid with the polar solvent, stirring the resulting mixture at room temperature or below the boiling temperature of the polar solvent, and finishing the reaction when the reaction mixture turns to dark-red or dark green.

The metal precursor may be a compound including one or more metals selected from the group consisting of gold, silver, copper, nickel, palladium and mixtures thereof. In embodiments, the metal precursor may be one or more compounds selected from the group consisting of AgNO₃, AgBF₄, AgPF₆, Ag₂O, CH₃COOAg, AgCF₃SO₃ , AgClO₄, AgCl, Ag₂O₄, CH₃COCH═COCH₃Ag, Cu(NO₃)₂, CuCl₂, CuSO₄, C₅H₇CuO₂, NiCl₂, Ni(NO₃)₂, NiSO₄, and HAuCl₄.

The polyacid is a polymer including one or more carboxyl groups or derivatives of the carboxyl group at a main chain or a side chain and having a polymerization degree of 10-100,000. Examples of the derivatives of the carboxyl group include sodium derivatives, potassium derivatives and ammonia derivatives of the carboxyl group, respectively. Further, the polyacid may be one or more compounds selected from the group consisting of poly(acrylic acid), poly(maleic acid), poly(methyl methacrylic acid), poly(acrylic acid-co-methacrylic acid), poly(maleic acid-co-acrylic acid), poly(acrylamide-co-acrylic acid) and sodium salts, potassium salts and ammonium salts thereof.

The polar solvent may be one or more solvents selected from the group consisting of water, alcohol, polyol, dimethylformamide (DMF), and dimethylsulfoxide (DMSO). Here, the alcohol may be one or more compounds selected from the group consisting of methanol, ethanol, 1-propanol, 2-propanol, 1-butanol, 2-butanol, isobutanol, hexanol, and octanol. Here, the polyol may be one or more compounds selected from the group consisting of glycerol, glycol, ethylene glycol, diethylene glycol, triethylene glycol, butandiol, tetraethylene glycol, propylene glycol, polyethylene glycol, polypropylene glycol, 1,2-pentadiol, and 1,2-hexadiol.

The polyacid may be mixed in 30-400 parts by weight with respect to 100 parts by weight of the metal precursor, and the polar solvent may be mixed in 100-2000 parts by weight with respect to 100 parts by weight of the metal precursor.

Here, the reaction temperature may range from 18 to 250° C., the reaction may be performed for 1-5 hours.

The method may further include adding a reducing agent to the reaction mixture at the mixing step or at the stirring step, wherein the reducing agent is one or more compounds selected from the group consisting of NaBH₄, LiBH₄, tetrabutylammonium borohydride, N₂H₄, glycol, glycerol, dimethylformamide, tannic acid, citrate and glucose. Further, the reducing agent may be added by 1-10 equivalents of metal ions of the metal precursor, and the reaction may be performed for 10 minutes-2 hours.

The method may further include cleaning the reaction mixture that includes metal nanoparticles with an organic solvent after the reaction completes and obtaining the metal nanoparticles by centrifugation.

Another aspect of the present invention may provide metal nanoparticles produced by the manufacturing method of the metal nanoparticles set forth above.

Here, the metal nanoparticles may include 70-99% of metal content and have 5-100 nm in diameter. The oxygen peak of the metal nanoparticles resulted from X-ray photoelectron spectroscopy may occupy 10-40% at 530.5±0.5 eV among total oxygen peaks.

Another aspect of the invention may provide colloid in which the metal nanoparticles are dispersed in a polar solvent.

Another aspect of the invention may provide conductive ink in which the metal nanoparticles are dispersed in a polar solvent.

### BRIEF DESCRIPTION OF THE DRAWINGS

FIG. 1 is a graph representing the result of TGA analysis for the metal nanoparticles produced according to an embodiment of the invention;

FIG. 2 is a graph representing the result of XRD analysis for the metal nanoparticles produced according to an embodiment of the invention;

FIG. 3 and FIG. 4 are graphs representing the result of XPS analysis for the metal nanoparticles produced according to embodiments of the invention;

FIGS. 5-11 are photos representing the results of SEM analysis for the metal nanoparticles produced according to embodiments of the invention; and

FIG. 12 is a photo representing the results of SEM analysis for the metal nanoparticles produced according to an embodiment of related art;

### DETAILED DESCRIPTION

Hereinafter, the method of producing metal nanoparticles and metal nanoparticles thus produced according to the present invention will be described in detail with reference to the accompanying drawings.

A method of producing metal nanoparticles of the present invention is performed in a water-based solvent or in a polar solvent, which has been known to provide a low yield rate. However, the present invention provides a manufacturing method of metal nanoparticles which allows obtaining metal nanoparticles to be stably dispersed in a water-based solvent or in a polar solvent by selectively using a stabilizing agent that has a uniform polymer form.

The stabilizing agent of the invention designates a material that allows metal nanoparticles to stably grow and form nano-sized particles in a solvent, or to disperse the nanoparticles stably in a solvent. The stabilizing agent is also called as a capping molecule or a dispersant. This stabilizing agent may be any known compound to those skilled in the art, particularly compounds which have oxygen, nitrogen or sulfur atoms, and more particularly, compounds having thiol groups (—SH), amine groups (—NH₂) or carboxyl groups (—COOH). In an embodiment of this invention, a compound having carboxyl groups is used as a stabilizing agent.

Among these compounds having carboxyl groups, a polyacid is used in the invention for producing nano-sized metal particles from a metal precursor under a polar solvent. The polyacid, which is a polymer, can stably disperse the particles having several tens of nm of a diameter, compared to monomolecular stabilizing agents, and also control the size of nanoparticles and provide stable dispersion of those nanoparticles with a use of much smaller amount, compared to PVP used as another polymer stabilizing agent.

In the invention, the polyacid may be a polymer that has one or more carboxyl groups or their derivatives in a main chain or a side chain, and a degree of polymerization of 10-100,000.

Here, the derivative designates a similar compound obtained by chemically changing some elements of a parent compound. The derivatives of the carboxyl group are compounds in which hydrogen atoms are substituted with other atoms or molecule such as sodium, potassium, or ammonium.

According to an embodiment of the invention, examples of such a polyacid may include polymers which have a main chain of carbon-to-carbon bonds (—C—C—) by opening carbon double bonds (C═C) and carboxyl groups in its main chain or side chains, or their derivatives of the carboxyl group substituted the hydrogen atoms with sodium, potassium or ammonium. Particular examples of the polyacid may include poly(acrylic acid), poly(maleic acid), poly(methyl methacrylic acid), poly(acrylic acid-co-methacrylic acid), poly(maleic acid-co-acrylic acid), and poly(acrylamide-co-acrylic acid); their sodium derivatives substituted the hydrogen atoms of one or more —COOH terminals of the polymer with sodiums, for example, sodium polyacrylate, sodium polymaleate, sodium poly(acrylate-co-methacrylate), sodium poly(maleate-co-acrylate) and sodium poly(acrylamide-co-acrylate); their potassium derivatives substituted the hydrogen atoms of one or more —COOH terminals of the polymer with potassiums, for example, potassium polyacrylate, potassium polymaleate, potassium poly(acrylate-co-methacrylate), potassium poly(maleate-co-acrylate) and potassium poly(acrylamide-co-acrylatepotassium); and their ammonium derivatives substituted the hydrogen atoms of one or more —COOH terminals of the polymer with ammonium ion (—NH₄), for example, ammonium salt of poly(acrylic acid), ammonium salt of poly(maleic acid), ammonium salt of poly(acrylic acid-co-methacrylic acid), ammonium salt of poly(maleic acid-co-acrylic acid) and ammonium salt of poly(acrylamide-co-acrylic acid).

Although the metals that can form metal nanoparticles by the polyacid are not particularly limited, examples of the metals may include gold, silver, copper, nickel, palladium and mixtures thereof on which many researches are generally focused.

The metal precursors, providing reducible metal ions to generate these metal nanoparticles, may be any salt including these metals without limitation; For example, not limited to these compounds, AgNO₃, AgBF₄, AgPF₆, Ag₂O, CH₃COOAg, AgCF₃SO₃, AgClO₄, AgCl, Ag₂SO₄, CH₃COCH═COCH₃Ag, Cu(NO₃)₂, CuCl₂, CuSO₄, C₅H₇CuO₂, NiCl₂, Ni(NO₃)₂, NiSO₄ and HAuCl₄ may be used as the metal precursor of the invention.

For dissociating the polyacid and the metal precursor, any polar solvent generally used in the art may be used in the invention without limitation. This polar solvent also functions as a reducing agent that leads metal ions to form metal nanoparticles. Example of the polar solvent may include water, alcohol, polyol, dimethylformamide (DMF), and dimethylsulfoxide (DMSO) and mixtures thereof. For example, DMF may be used by mixing with water or polyol such as ethylene glycol.

Here, examples of the alcohol may include methanol, ethanol, 1-propanol, 2-propanol, 1-butanol, 2-butanol, isobutanol, hexanol, and octanol.

Here, the polyols designates water-soluble monomers and polymers of low molecular weight, having more than 2 of hydroxyl groups. Since the polyols used in this invention are solvents that can function as not only a reducing agent but a stabilizing agent, they can be properly used as a polar solvent. Examples of these polyols may include glycerol, glycol, ethylene glycol, diethylene glycol, triethylene glycol, butandiol, tetraethylene glycol, 1,2-pentadiol and 1,2-hexadiol. It is, however, apparent that any polyol, not limited to them, may be used within a scope apparent to those skilled in the art.

The method of producing metal nanoparticles of the invention is described in detail hereinafter. The method of producing metal nanoparticles of the invention may include mixing a metal precursor and a polyacid with a polar solvent, stirring the reaction mixture at room temperature or below the boiling temperature of the polar solvent, and completing the reaction when the reaction mixture turns to dark-red or dark-green.

In the mixing step, the polyacid is mixed by 30-400 parts by weight with respect to 100 parts by weight of the metal precursor. If the polyacid is added by less than 30 parts by weight, it is difficult to control the size of metal particles and a yield rate decreases, and if it is by more than 400 parts by weight, the efficiency decreases.

Also, the polar solvent is used by 100-2000 parts by weight, preferably 200˜500 parts by weight, with respect to 100 parts by weight of the metal precursor. If the polar solvent is used by less than 100 parts by weight, the metal precursor is not readily dissociated. If the polar solvent is used by more than 2000 parts by weight, it is inefficient in an economical point of view.

In the stirring step, the reaction mixture mixed with such ratios is stirred to perform reduction at a uniform temperature. The stirring can be performed at room temperature or below the boiling temperature of the polar solvent used in the procedure. When a reducing agent is added, the stirring temperature may be lower than that when a reducing agent is not added. At lower than room temperature, the reduction itself hardly occurs. On the other hand at higher than the boiling temperature of a polar solvent, it is difficult to control the reaction stably because of side reactions. According to an embodiment of this invention, the stirring temperature may be 18-250° C., preferably 50-200° C. When a reducing agent is not added, the stirring temperature is increased to supply enough energy needed for initiating the reaction and controlling the reaction rate. At this time, the temperature is increased uniformly, so that the metal particles grow uniformly and thus, it is profitable to control the size.

Through the reaction, the reaction mixture turns from yellow to blackish red and further to dark green (or bile color). According to an embodiment of the invention, it is noticeable that small metal particles are formed at blackish red color, and large-sized nanoparticles are formed at dark green color. The reaction may be stopped at blackish red or dark green, according to the desired particle size.

The reaction time forming the nanoparticles may vary with mixing ratio of components, stirring temperature, use or no use of a reducing agent. For example, the reaction time may be 1-5 hours.

The reaction can progress more easily by adding additional reducing agent beside the polar solvent at the mixing step or stirring step. This reducing agent may be general reducing agents that are used for producing metal nanoparticles in a water-based or polar solvent. Example of the reducing agent includes NaBH₄, LiBH₄, tetrabutylammonium borohydride, N₂H₄, dimethylformamide, tannic acid, citrate and glucose. The reducing agent is added by 1-10 equivalents of metal ions generated from the metal precursor, and can affect the size of metal nanoparticles and the reaction rate. For example, by using the reducing agent, metal nanoparticles can be obtained through a reaction performed for 10 minutes-2 hours.

Also, the method of producing metal nanoparticles may further include obtaining metal nanoparticles produced in a solution, within a scope apparent to skilled in the art. For example, it includes cleaning the reaction mixture including metal nanoparticles with an organic solvent after the reaction completes and obtaining the metal nanoparticles by centrifugation. Besides, drying the obtained particles may be further added. Here, example of the organic solvents may include methanol, ethanol, DMF and mixtures thereof.

The formation of silver nanoparticles is shown below as an example of this procedure.

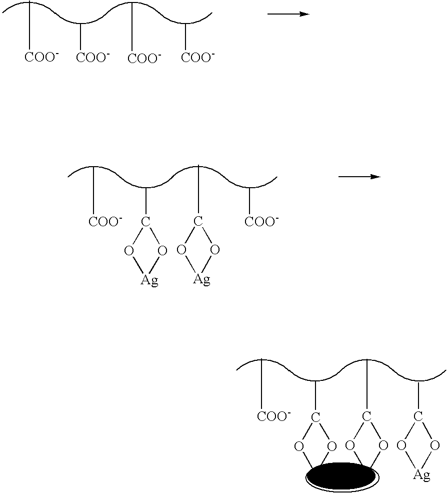

It shows that metal atoms bind to the terminals of carboxyl groups and grow to a certain size via reduction. A long polymer chain of the polyacid stably isolates metal nanoparticles, e.q., silver particles, so that the nanoparticles grow uniformly without agglomerating each other and disperse stably.

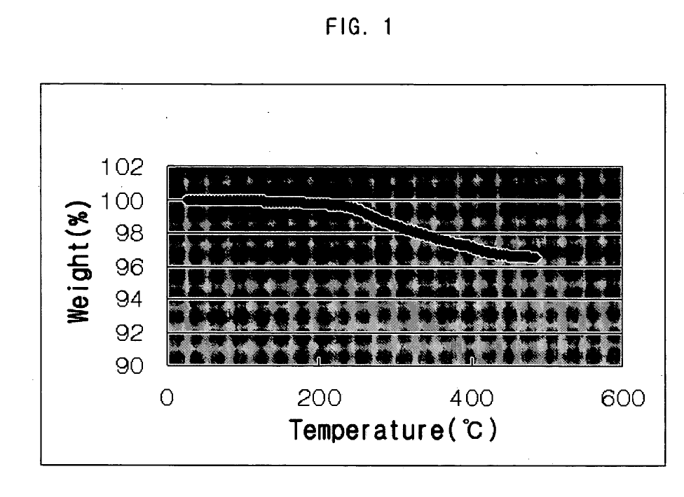

FIG. 1 is a graph representing the result of TGA analysis for the metal nanoparticles produced according to an embodiment of the invention. Referring to FIG. 1, which is the result of TGA analysis for the metal nanoparticles having 30-40 nm of diameter, it is shown that about 4 weight % organic materials are included in the nanoparticles. Through the analysis, the amount of a capping molecule that contributes to the dispersion stability of the produced. nanoparticles can be estimated. In case of the mean diameter of the obtained nanoparticles is about below 10 nm, the amount of an organic material is about below 20 weight %. In other words, the metal nanoparticles produced by the invention have 70-99% of metal contents.

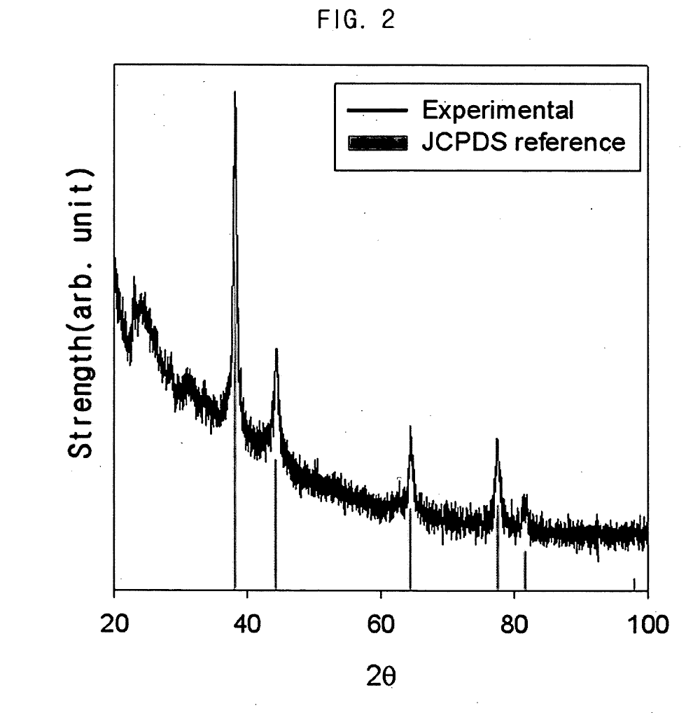

FIG. 2 is a graph representing the result of XRD (X-ray diffraction) of the metal nanoparticles produced according to an embodiment of the invention. Referring to FIG. 2, it is shown that the graph representing the result of XRD (X-ray diffraction) of the metal nanoparticles exactly coincide with the Card No. 4-0783 (pure silver) of Joint Committee for Powder Diffraction Standards (JCPDS).

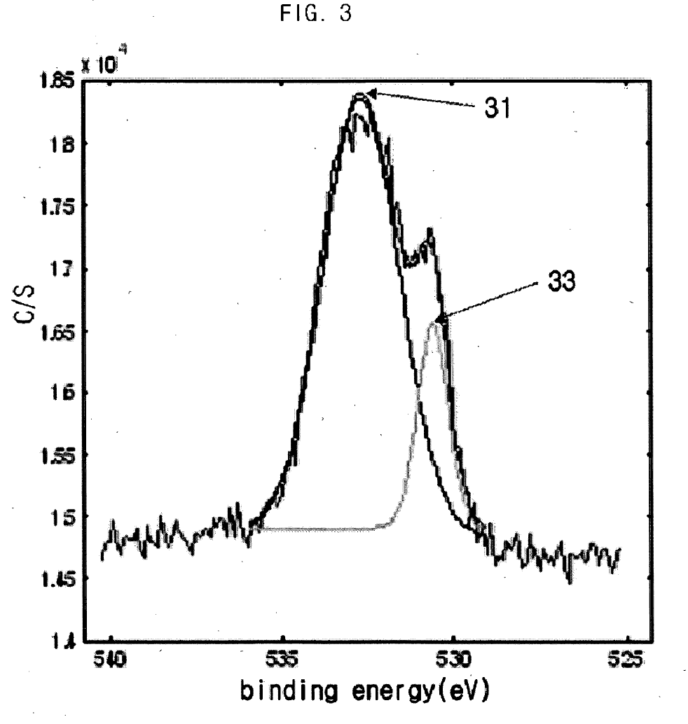

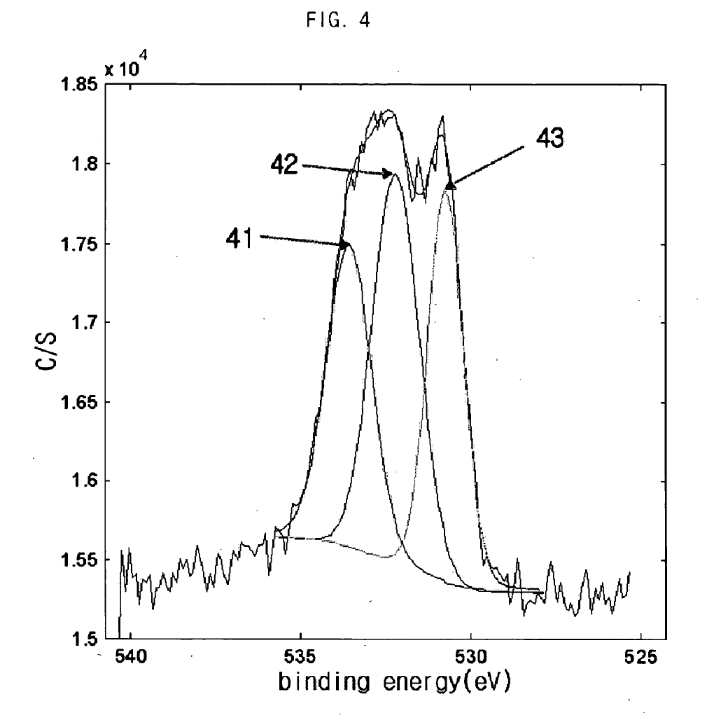

FIG. 3 and FIG. 4 are graphs representing the results of X-ray photoelectron spectroscopy (XPS). FIG. 3 is a graph representing the results of XPS of the silver nanoparticles manufactured using poly(acrylic acid) according to an embodiment of the invention. This graph shows two separated O1s peaks, one peak 31 at 533±1 eV where oxygen atoms do not bind with silver and the other peak 33 at 530.5±0.5 eV where oxygen atoms bind with silver. Here, the peak 31, where oxygen atoms do not bind with silver, indicates oxygen atoms in the carboxyl groups that still has H, as shown in

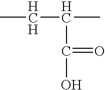

(structural formula 1). Further, the peak 33, where oxygen atoms bind with silver, indicates oxygen atoms in the carboxyl groups where H has been substituted with metals such as Ag, as shown in

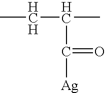

(structural formula 2).

FIG. 4 is a graph representing the result of XPS of the silver nanoparticles manufactured by using sodium polyacrylate or ammonium salt of poly(acrylic acid) according to an embodiment of the invention. The result shows three separated O1s peaks, one peak 41 at 533±1 eV where oxygen atoms do not bind with silver, another peak 43 at 530.5±0.5 eV where oxygen atoms bind with silver, and the other peak 42 at 532±1 eV where oxygen atoms bind with substitutents such as sodium, potassium, ammonium Here, the peaks 41 and 43 correspond to the peaks 31 and 33 of FIG. 3, respectively. The peak 42 represents the oxygen atom of the carboxyl group where H is substituted with sodium, potassium or ammonium, as shown in

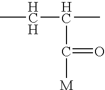

(structural formula 3), wherein M is sodium, potassium, or ammonium substituted with H of the carboxyl group.

In such analyses, among the organic materials of metal nanoparticles, a ratio of the carboxyl groups of structural formula 2 that contribute to the stability of the produced metal nanoparticles and the carboxyl groups of structural formula 1 that contribute to the dispersion stability in a solvent can be deduced. It is shown that the oxygen peaks 33, 43 at 530.5±0.5 eV occupy 10-40% of the total oxygen peaks.

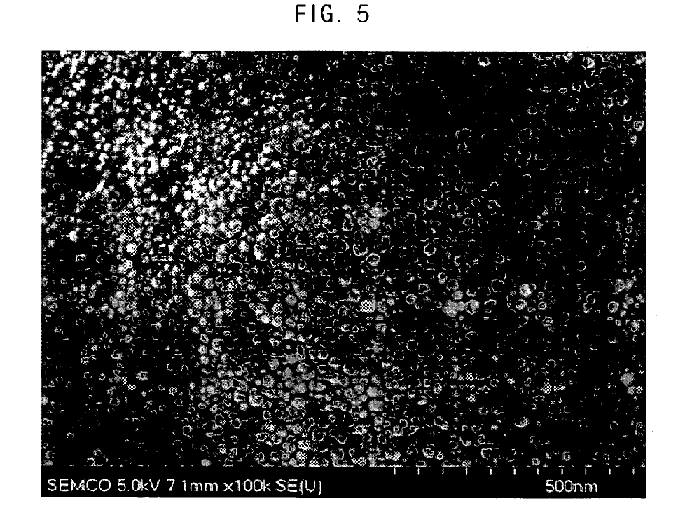

FIGS. 5-11 are photographs representing SEM results of metal nanoparticles according to an embodiment of the invention. The photos show that uniform metal nanoparticles having 5-100 nm in diameter are produced through the invention.

The following examples are included to demonstrate embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

100 parts by weight of silver nitrate (AgNO₃) and 85 parts by weight of PAA were dissolved in 500 parts by weight of ethylene glycol (EG) while stirring. When the temperature of the solution was raised to 160° C., the transparent solution began to turn to yellow color. The color of the solution gradually turned to dark red, and eventually turned to dark-green. After acetone was added to the dark green colored solution, silver nanoparticles were harvested by centrifugation. Here, the silver nanoparticles showed a high yield rate of 85 parts by weight, and the mean particles size was about 20-30 nm. Here, the yield rate was calculated by the ratio of mass of the re-dispersed silver nanoparticles to mass of the pure silver added, for example, when 170 g of AgNO₃ was added, mass of the added pure silver was 108 g. The SEM photo of the metal nanoparticles thus produced is illustrated in FIG. 5.

### EXAMPLE 2

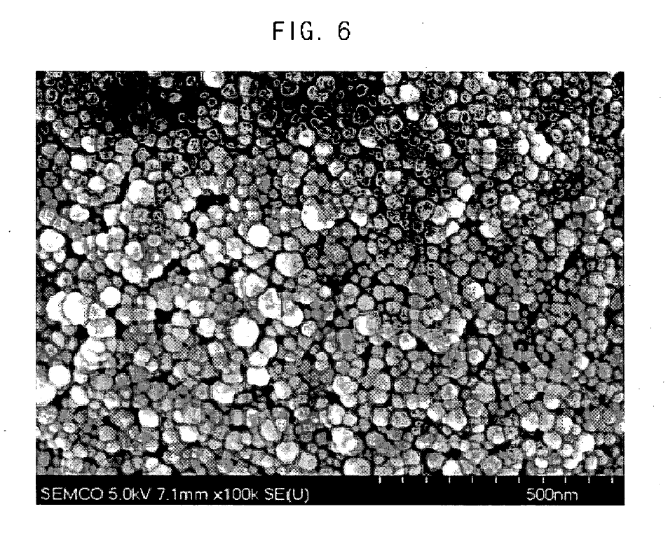

100 parts by weight of silver nitrate (AgNO₃) and 85 parts by weight of PAA were dissolved in 500 parts by weight of ethylene glycol (EG) while stirring. When the temperature of the solution was raised to 170° C., the transparent solution began to turn to yellow color. The color of the solution gradually turned to dark red. When the temperature of the solution wais raised to 190° C., it eventually turned to dark green. After acetone was added to the dark green colored solution, silver nanoparticles were harvested by centrifugation. Here, the silver nanoparticles showed a high yield rate of 95 parts by weight, and the mean particles size was about 30-40 nm. The SEM photo of the metal nanoparticles thus produced is illustrated in FIG. 6.

### EXAMPLE 3

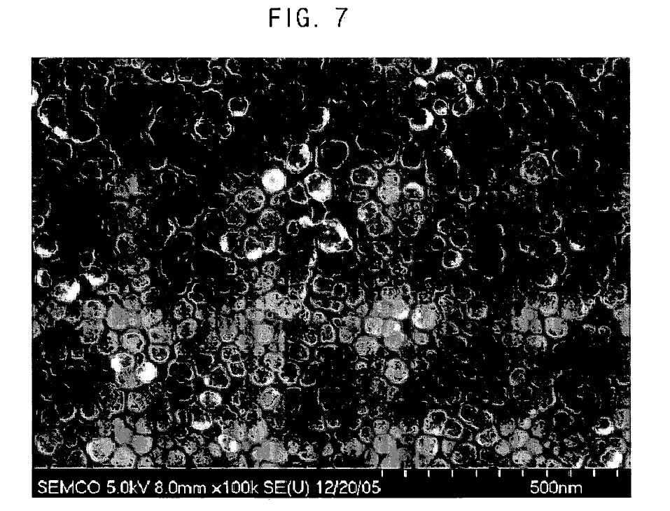

100 parts by weight of silver nitrate (AgNO₃) and 43 parts by weight of poly(acrylic acid) are dissolved in 500 parts by weight of ethylene glycol (EG) while stirring. When the temperature of the solution was raised to 170° C., the solution began to turn from an obscure color to transparent yellow color. The color of the solution gradually turned to dark red, eventually turned to dark green. After acetone was added to the dark green colored solution, silver nanoparticles were harvested by centrifugation. Here, the silver nanoparticles showed a high yield rate of 60 parts by weight, and the mean particles size was about 20-30 nm. The SEM photo of the metal nanoparticles thus produced is illustrated in FIG. 7.

### EXAMPLE 4

100 parts by weight of silver nitrate (AgNO₃) and 90 parts by weight of poly(acrylic acid) sodium were dissolved in 500 parts by weight of ethylene glycol (EG) while stirring. When the temperature was raised to 160° C., the solution began to turn from an obscure white color to transparent yellow color. Eventually the color of the solution gradually turned to dark red. After acetone was added to the dark red colored solution, silver nanoparticles were harvested by centrifugation. Here, the silver nanoparticles showed a high yield rate of 88 parts by weight, and the mean particles size was about 10 nm.

### EXAMPLE 5

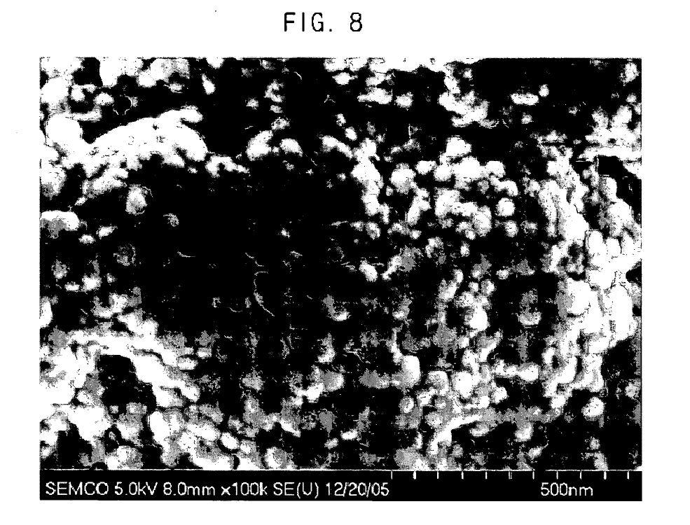

100 parts by weight of silver nitrate (AgNO₃) and 43 parts by weight of poly(acrylic acid) were dissolved in 500 parts by weight of dimethylformamide (DMF) while stirring. When the temperature is raised to 150° C., the solution began to turn from an obscure white color to transparent yellow color. The color of the solution gradually turned to dark red, eventually turned to dark green. After acetone was added to the dark green colored solution, silver nanoparticles were harvested by centrifugation. Here, the silver nanoparticles showed a high yield rate of 75 parts by weight, and the mean particles size was about 30-40 nm. The SEM photo of the metal nanoparticles thus produced is illustrated in FIG. 8.

### EXAMPLE 6

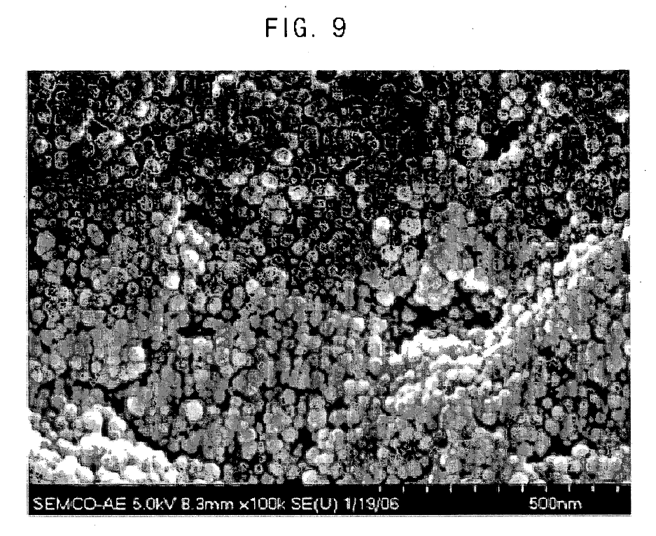

100 parts by weight of silver nitrate (AgNO₃) and 43 parts by weight of poly(acrylic acid) were dissolved in 500 parts by weight of glycol while stirring. When the temperature of the solution was raised to 220° C., the solution began to turn from an obscure white color to transparent yellow color. Eventually the color of the solution gradually turned to dark red. After acetone was added to the dark red colored solution, silver nanoparticles were harvested by centrifugation. Here, the silver nanoparticles showed a high yield rate of 68 parts by weight, and the mean particles size was about 10 nm. The SEM photo of the metal nanoparticles thus produced is illustrated in FIG. 9.

### EXAMPLE 7

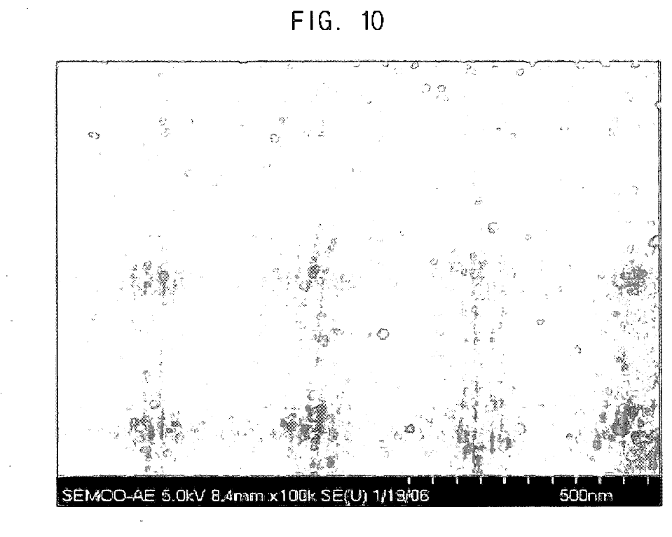

100 parts by weight of silver nitrate (AgNO₃) and 50 parts by weight of poly(acrylic acid) ammonium were dissolved in 500 parts by weight of ethylene glycol (EG) while stirring. When the temperature of the solution was raised to 170° C., the solution began to turn from an obscure white color to transparent yellow color. The color of the solution gradually turned to dark red, eventually turned to dark green. After acetone was added to the dark green colored solution, silver nanoparticles were harvested by centrifugation. Here, the silver nanoparticles showed a high yield rate of 68 parts by weight, and the mean particles size was about 20-30 nm. The SEM photo of the metal nanoparticles thus produced is illustrated in FIG. 10.

### EXAMPLE 8

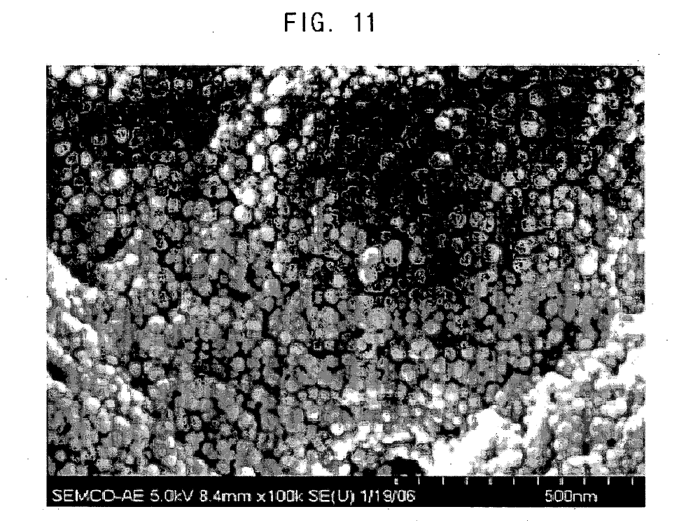

100 parts by weight of silver nitrate (AgNO₃) and 43 parts by weight of poly(acrylic acid) were dissolved in 500 parts by weight of water while stirring. When a reducing agent NaBH₄ was added, the solution began to turn to dark red color. After acetone was added to the dark red colored solution, silver nanoparticles were harvested by centrifugation. Here, the silver nanoparticles showed a high yield rate of 50 parts by weight, and the mean particles size was about 15 nm. The SEM photo of the metal nanoparticles thus produced is illustrated in FIG. 11.

### COMPARISON EXAMPLE 1

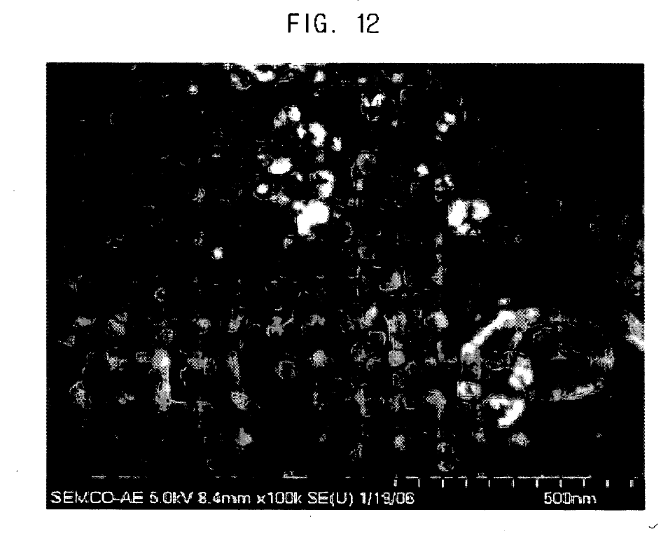

100 parts by weight of silver nitrate (AgNO₃) and 85 parts by weight of poly(vinyl pyrrolidone) ammonium were dissolved in 500 parts by weight of ethylene glycol (EG) while stirring. When the temperature the solution was raised to 150° C., the solution began to turn to yellow or gray, and then acetone was added to the solution and silver nanoparticles were harvested by centrifugation. Here, the silver nanoparticles thus obtained had very unequal size and poor dispersion stability. The actual yield rate of the silver nanoparticles re-dispersed stably in ethanol was less than 5%. The SEM photo of the metal nanoparticles thus produced is illustrated in FIG. 12.

### COMPARISON EXAMPLE 2

100 parts by weight of silver nitrate (AgNO₃) and 400 parts by weight of poly(vinyl pyrrolidone) ammonium were dissolved in 500 parts by weight of water while stirring. When the temperature of the solution was raised to 100° C., the solution turned to dark green, and then acetone was added to the solution and silver nanoparticles were harvested by centrifugation. The silver nanoparticles thus obtained had a very low yield rate of less than 3%.

Production of Conductive Ink

100 g of 10-30 nm silver nanoparticles produced by each of Examples 1-8 was added to an aqueous solution of ethanol and diethylene glycol butyl ether acetate, and dispersed with an ultra sonicator to produce 20 cps of conductive ink. The conductive ink thus produced may be printed on a circuit board via inkjet techniques to form conductive wiring.

Although a few embodiments of the present invention have been shown and described, it will be appreciated by those skilled in the art that changes may be made in these embodiments without departing from the principles and spirit of the present invention, the scope of which is defined in the appended claims and their equivalents.

What is claimed is:

1. A method of producing metal nanoparticles, manufacturing metal nanoparticles from a metal precursor using a polyacid as a stabilizing agent in a polar solvent.

2. The method of claim 1, wherein a reducing agent is further added.

3. The method of claim 1, the method comprising:
mixing a metal precursor and a polyacid with a polar solvent;
stirring the resulting mixture at room temperature or below the boiling temperature of the polar solvent; and
completing the reaction when the reaction mixture turns to dark red or dark green.

4. The method of claim 3, wherein the metal precursor is a compound that includes one or more metals selected from the group consisting of gold, silver, copper, nickel, palladium and mixtures thereof.

5. The metal precursor of claim 4, wherein the metal precursor is one or more compound selected from the group consisting of AgNO₃, AgBF₄, AgPF₆, Ag₂O, CH₃COOAg, AgCF₃SO₃, AgClO₄, AgCl, Ag₂SO₄, CH₃COCH═COCH₃Ag, Cu(NO₃)₂, CuCl₂, CuSO₄, C₅H₇CuO₂, NiCl₂, Ni(NO₃)₂, NiSO₄ and HAuCl₄.

6. The method of claim 3, wherein the polyacid is a polymer that has one or more carboxyl groups or their derivatives in a main chain or a side chain and a polymerization degree of 10-100,000.

7. The method of claim 6, wherein the derivatives of the carboxyl group include sodium derivatives of the carboxyl group, potassium derivatives of the carboxyl group or ammonium derivatives of the carboxyl group.

8. The method of claim 6, wherein the polyacid is one or more compounds selected from the group consisting of poly(acrylic acid), poly(maleic acid), poly(methyl methacrylic acid), poly(acrylic acid-co-methacrylic acid), poly(maleic acid-co-acrylic acid), poly(acrylamide-co-acrylic acid) and their sodium salt, their potassium salt and their ammonium salt.

9. The method of claim 3, wherein the polar solvent is one or more solvent selected from the group consisting of water, alcohol, polyol, dimethylformamide (DMF), and dimethylsulfoxide (DMSO).

10. The method of claim 9, wherein the alcohol is one or more compounds selected from the group consisting of methanol, ethanol, 1-propanol, 2-propanol, 1-butanol, 2-butanol, isobutanol, hexanol, and octanol.

11. The method of claim 9, wherein the polyol is one or more compounds selected from the group consisting of glycerol, glycol, ethylene glycol, diethylene glycol, triethylene glycol, butandiol, tetraethylene glycol, propylene glycol, polyethylene glycol, polypropylene glycol, 1,2-pentadiol and 1,2-hexadiol.

12. The method of claim 3, wherein the polyacid is added in 30-400 parts by weight with respect to 100 parts by weight of the metal precursor.

13. The method of claim 3, wherein the polar solvent is added in 100-2000 parts by weight with respect to 100 parts by weight of the metal precursor.

14. The method of claim 3, wherein the temperature is 18-250° C.

15. The method of claim 3, wherein the reaction is performed for 1-5 hours.

16. The method of claim 3, further comprising adding a reducing agent to the reaction mixture at the mixing step or at the stirring step.

17. The method of claim 16, wherein the reducing agent is one or more compounds selected from the group consisting of NaBH₄, LiBH₄, tetrabutylammonium borohydride, N₂H₄, glycol, glycerol, dimethylformamide, tannic acid, citrate and glucose.

18. The method of claim 16, wherein the reducing agent is added by 1-10 equivalents of metal ions of the metal precursor.

19. The method of claim 16, wherein the reaction is performed for 10 minutes-2 hours.

20. The method of claim 3, further comprising cleaning the reaction mixture including metal nanoparticles with an organic solvent after the reaction completes and obtaining the metal nanoparticles with centrifugation.

21. Metal nanoparticles manufactured by the method of claim 1.

22. The metal nanoparticles of claim 21, wherein the metal nanoparticles comprises 70-99% of metal contents.

23. The metal nanoparticles of claim 21, wherein the metal nanoparticles have a diameter of 5-100 nm.

24. The metal nanoparticles of claim 21, wherein the metal nanoparticles have 10-40% of the oxygen peak among total oxygen peaks at 530.5±0.5 eV in the X-ray photoelectron spectroscopy analysis.

25. Colloid in which the metal nanoparticles of claim 21 are dispersed in a polar solvent.

26. Conductive ink in which the metal nanoparticles of claim 21 are dispersed in a polar solvent.

27. Metal nanoparticles manufactured by the method of claim 3.

28. The metal nanoparticles of claim 27, wherein the metal nanoparticles comprises 70-99% of metal contents.

29. The metal nanoparticles of claim 27, wherein the metal nanoparticles have a diameter of 5-100 nm.

30. The metal nanoparticles of claim 27, wherein the metal nanoparticles have 10-40% of the oxygen peak among total oxygen peaks at 530.5±0.5 eV in the X-ray photoelectron spectroscopy analysis.

31. Colloid in which the metal nanoparticles of claim 27 are dispersed in a polar solvent.

32. Conductive ink in which the metal nanoparticles of claim 27 are dispersed in a polar solvent.
